(19) United States
(12) Patent Application Publication
(10) Pub. No.: US 2026/0227495 A1
(43) Pub. Date: Aug. 6, 2026

(54) CONTROL METHOD FOR SOLID-STATE LIDAR AND SOLID-STATE LIDAR

(71) Applicant: SUZHOU SOPHOTON TECH CO. LTD., Jiangsu (CN)

(72) Inventors: Yan ZHAO, Jiangsu (CN); Tianyang WANG, Jiangsu (CN); Xian SU, Jiangsu (CN)

(21) Appl. No.: 19/151,801

(22) PCT Filed: Jan. 19, 2024
(86) PCT No.: PCT/CN2024/073176

§ 371 Date: Jul. 29, 2025

(30) Foreign Application Priority Data
Jan. 29, 2023 (CN) 202310043864.0

(51) Int. Cl. G01S 7/4863; G01S 7/481; G01S 7/484

(52) U.S. Cl. CPC G01S 7/4863; G01S 7/4815; G01S 7/484

(57) ABSTRACT

A method for controlling a solid-state lidar and a solid-state lidar are provided. The solid-state lidar includes a planar laser array comprising a plurality of laser partitions and a detector array comprising a plurality of detector partitions. The plurality of detector partitions is grouped into a plurality of detector blocks each including at least two detector partitions and coupled to a different processing module. The method includes: controlling at least one laser partition to emit laser light, each of the at least one target detector partition corresponding to at least one laser partition is located in a different detector block (S401); controlling the at least one target detector partition to receive reflected laser signals (S403); based on a processing module coupled to the detector block that the detector partition is located, processing the reflected laser signals received by each target detector partition (S405). With this method, scanning can be performed by the solid-state lidar based on two-dimensional addressing with higher efficiency at increased frame rate.

### TECHNICAL FIELD

The present application relates to the field of laser radar (lidar) technology, and more particularly to a method for controlling a solid-state lidar and a solid-state lidar.

### BACKGROUND

Solid-state lidars have become the most promising lidar technique thanks to their outstanding advantages such as high system integration, easy large-scale mass production, high system reliability and low production cost. Among solid-state lidars, fully solid-state flash lidars have found increasingly wide application.

A fully solid-state flash lidar incorporates a planar laser array as a transmitter and a planar array of photosensitive elements as a receiver. Limited by transmit power of the laser emitters, parallel signal processing capability of the receiver and other factors, in the prior art, the planar laser array is divided into a number of subarrays, which are successively activated, followed by the activation of a respective subset of photosensitive elements in the receiver. However, this partition scanning approach is problematic in reduced scanning efficiency and a decreased frame rate.

### SUMMARY OF THE INVENTION

Embodiments disclosed herein address the above described problems with the prior art by presenting a method for controlling a solid-state lidar and a solid-state lidar, as detailed below.

In one aspect, there is provided a method for controlling a solid-state lidar comprising a planar laser array and a detector array. The planar laser array comprises a plurality of laser partitions, and the detector array comprises a plurality of detector partitions. Each laser partition comprises a plurality of laser elements. The plurality of laser partitions is in one-to-one correspondence with the plurality of detector partitions. The plurality of detector partitions is grouped into a plurality of detector blocks each comprising at least two detector partitions and coupled to a different processing module. The method comprises:
controlling at least one laser partition to emit laser light, wherein each of at least one target detector partition corresponding to the at least one laser partitions is located in a different detector block;
controlling the at least one target detector partition to receive reflected laser signals; and
based on a target processing module corresponding to each target detector partition, processing the reflected laser signals received by each target detector partition, wherein the target processing module is a processing module that the detector block where the target detector partition is located is coupled to.

In an exemplary embodiment, the plurality of laser partitions may be grouped into a plurality of laser blocks each comprising at least two of the laser partitions and corresponding to a different detector block,
wherein controlling the at least one laser partition to emit the laser light comprises:
determining at least one laser block to be activated from the plurality of laser blocks;
based on a predefined partition activation order corresponding to each laser block to be activated, determining a laser partition to be currently activated in each laser block to be activated; and
controlling the laser partition to be currently activated in each laser blocks to be activated to emit the laser light.

In an exemplary embodiment, each laser block may be coupled to a respective driving module comprising a plurality of charging modules and a plurality of discharging modules, the plurality of charging modules and the plurality of discharging modules form a plurality of driving channels,
wherein input terminals of a same column of laser partitions in each laser block are connected to a same charging module in a corresponding respect driving module, and output terminals of each row of laser partitions in each laser block are connected to a same discharging modules in a corresponding driving module.

In an exemplary embodiment, the plurality of laser blocks may be arranged into an array, with the plurality of detector blocks being arranged into an array,
wherein each row of the plurality of laser blocks is coupled to a corresponding driving module, wherein the driving module comprises a plurality of charging modules and a plurality of discharging modules, and wherein the plurality of charging modules and the plurality of discharging modules form a plurality of driving channels;
output terminals of each row of the laser partitions in each row of the laser block are connected to a same discharging module in a corresponding driving module; and
input terminals of each column of laser partitions in each laser block in a same row of laser blocks are connected to a same charging module in a corresponding driving module.

In an exemplary embodiment, controlling the laser partition to be currently activated in each laser block to be activated to emit the laser light may comprise:
for a laser partition to be currently activated in each laser block to be activated:
controlling a target charging module to which the laser partition to be currently activated is coupled to enter a charging state; and
controlling a target discharging module to which the laser partition to be currently activated is coupled to enter a discharging state, thereby activating a target driving channel that is formed by the target charging module and the target discharging module, so as to drive the laser partition to be currently activated in the laser block to be activated to emit the laser light.

In another aspect, there is provided a solid-state lidar comprising:
a transmitter unit comprising a planar laser array including a plurality of laser partitions each comprising a plurality of laser elements;
a receiver unit comprising a detector array and a plurality of processing modules, the detector array comprising a plurality of detector partitions in one-to-one correspondence with the plurality of laser partitions, the plurality of detector partitions grouped into a plurality of detector blocks each comprising at least two detector partitions and coupled to a different processing module; and
a control unit coupled to each of the transmitter unit and the receiver unit, the control unit configured to: control at least one laser partition to emit laser light; control at least one target detector partition which corresponds to the at least one laser partition to receive reflected laser signals; and based on each target processing module corresponding to a target detector partition, processing the reflected laser signals received by each target detector partition, wherein each of at least one target detector partition is located in a different detector block, and wherein the target processing module is a processing module that the detector block where the detector partition is located is coupled to.

In an exemplary embodiment, the plurality of laser partitions in the planar laser array may be grouped into a plurality of laser blocks each comprising at least two laser partitions and corresponding to a different detector block,
wherein controlling the at least one laser partition to emit the laser light, the control unit is configured to: determine at least one laser block to be activated from the plurality of laser blocks; based on a predefined partition activation order corresponding to each laser block to be activated, determine a laser partition to be currently activated in the laser block to be activated; and control the laser partition to be currently activated in each laser block to be activated to emit the laser light.

In an exemplary embodiment, the transmitter unit may further comprise a plurality of driving modules each coupled to a respective one of the laser blocks, each driving module comprising a plurality of charging modules and a plurality of discharging modules, which together form a plurality of driving channels,
wherein input terminals of a same column of laser partitions in each laser block are connected to a same charging module in a corresponding driving module, and wherein output terminals of a same row of laser partitions in each laser block are connected to a same discharging modules in a corresponding driving module.

In an exemplary embodiment, the plurality of laser blocks may be arranged into an array, with the plurality of detector blocks being arranged into an array,
wherein the transmitter unit further comprises a plurality of driving modules each coupled to a same row of laser blocks of the plurality of laser blocks, each driving module comprising a plurality of charging modules and a plurality of discharging modules, which together form a plurality of driving channels;
output terminals of a same row of laser partitions in a same laser block are connected to a same discharging module in a corresponding driving module; and
input terminals of a same column of laser partitions in each laser block in a same row of laser blocks are connected to a same charging module in a corresponding driving module.

In an exemplary embodiment, controlling the laser partition to be currently activated in each laser block to be activated to emit the laser light, the control unit is configured to, for a laser partition to be currently activated in each laser block to be activated, control target charging module to which the laser partition to be currently activated is coupled to enter a charging state; and control a target discharging module to which the laser partition to be currently activated is coupled to enter a discharging state, thereby activating the driving channel that is formed by the target charging module and the target discharging module, so as to drive the laser partition to be currently activated in the laser block to be activated to emit the laser light.

According to embodiments disclosed herein, a plurality of detector partitions in a detector array is grouped into a plurality of detector blocks each comprising at least two of the detector partitions and coupled to a different processing module. Accordingly, at least one laser partition is controlled to emit laser light, each of at least one detector partition corresponding to at least one laser partition is located in a different detector block, and the at least one detector partition may be controlled to receive reflected laser signal. Moreover, based on a target processing module corresponding to each target detector partition, processing the reflected laser signals received by each target detector partition, wherein the target processing module is a processing module that the detector block where the target detector partition is located is coupled to. In this way, parallel processing can be achieved by the processing modules coupled to the respective detector blocks, enabling the solid-state lidar to perform scanning based on two-dimensional addressing with higher scanning efficiency at an increased frame rate. Alternatively, the size of the partition is allowed to be reduced several times at the same scanning efficiency. Smaller partitions mean reduced likelihood of crosstalk between different detection channels.

### BRIEF DESCRIPTION OF THE DRAWINGS

In order to more clearly illustrate the subject matter disclosed herein, the accompanying drawings that form a part hereof are now briefly described. Apparently, these drawings show only some possible embodiments of the invention, and those of ordinary skill in the art can obtain different figures in light of those described herein without paying any creative effort.

FIG. 1 shows an example of laser partitions in a planar laser array operating in a scanning mode based on two-dimensional addressing according to an embodiment disclosed herein.

FIG. 2 shows how laser partitions are driven to operate in a scanning mode based on two-dimensional addressing according to an embodiment disclosed herein.

FIG. 3a schematically illustrates an arrangement of a plurality of detector blocks in a detector array according to an embodiment disclosed herein.

FIG. 3b schematically illustrates another arrangement of a plurality of detector blocks in the detector array according to an embodiment disclosed herein.

FIG. 3c schematically illustrates yet another arrangement of a plurality of detector blocks in the detector array according to an embodiment disclosed herein.

FIG. 4 is a schematic flowchart of a method for controlling a solid-state lidar according to an embodiment disclosed herein.

FIG. 5a schematically illustrates an arrangement of a plurality of laser blocks according to an embodiment disclosed herein.

FIG. 5b schematically illustrates another arrangement of a plurality of laser blocks according to an embodiment disclosed herein.

FIG. 5c schematically illustrates yet another arrangement of a plurality of laser blocks according to an embodiment disclosed herein.

FIG. 6 is a schematic flowchart of another method for controlling a solid-state lidar according to an embodiment disclosed herein.

FIG. 7a schematically illustrates coupling of driving modules corresponding to FIG. 5a according to an embodiment disclosed herein.

FIG. 7b schematically illustrates coupling of driving modules corresponding to FIG. 5b according to an embodiment disclosed herein.

FIG. 7c schematically illustrates coupling of driving modules corresponding to FIG. 5c according to an embodiment disclosed herein.

FIG. 8 schematically illustrates alternative coupling of driving modules corresponding to FIG. 5c according to an embodiment disclosed herein.

FIG. 9 shows an example of activated laser partitions in a plurality of laser blocks according to an embodiment disclosed herein.

FIG. 10 is a schematic diagram showing the structure of a solid-state lidar according to an embodiment disclosed herein.

### DETAILED DESCRIPTION

Embodiments of the present application will be described clearly and fully hereunder in conjunction with the appended drawings. Evidently, the embodiments set forth herein are merely some but not all possible embodiments of the application. Any and all other embodiments devisable by skilled artisans in light of the disclosed embodiments without paying any creative effort are considered to fall within the scope of protection of this application.

It should be noted that the terms “first,” “second,” and the like (if present) in the description, claims and drawings of the application are used for distinguishing between similar elements and not necessarily for describing a particular sequential or chronological order. It will be understood that the terms so used are interchangeable under appropriate circumstances such that the embodiments described herein are capable of operation in sequences other than those illustrated or otherwise described herein. In addition, the terms “include,” “have,” and any variations thereof, are intended to cover a non-exclusive inclusion, such that, for example, a process, method, system, article or server that comprises a list of elements or steps is not necessarily limited to those listed elements or steps, but may include other elements or steps not expressly listed or inherent to such process, method, article or apparatus.

It will be understood that, as used herein, the terms “row”, “column”, “central”, “longitudinal”, “transverse”, “length”, “width”, “thickness”, “up”, “down”, “front”, “rear”, “left”, “right”, “vertical”, “horizontal”, “top”, “bottom”, “inner”, “outer”, “clockwise”, “counterclockwise” and so on may be used herein to describe orientations or positional relationships as viewed in the annexed figures. They are for convenience and ease of description of the present invention only and do not indicate or imply that the described apparatus or element must comprise, or be constructed or operated in, a particular orientation. Therefore, they are not to be construed as limiting the present invention.

A fully solid-state flash lidar is used to determine a distance S of a detecting target, by transmitting a laser pulse from a planar laser array to the target detection area and detecting a reflected laser signal by a receiver, from the difference between the time of reception t₂ and the time of transmission t₁, according to

$$S = \frac{{t}_{2} - {t}_{1}}{2} C ,$$

where C represents the speed of light.

Ideally, all laser emitters in the planar laser array are simultaneously activated to irradiate laser light over the entire target detection area, and respective photosensitive elements in the detector receive reflected laser signals, accomplishing full field of view detection in one pass. This is, however, impractical at the present time due to limited transmit power of the laser emitters, inadequate parallel signal processing capability of the receiver and other limitations. In the prior art, the transmitter is divided into a number of subarrays, which are successively activated, each followed by the activation of a respective photosensitive elements in the receiver, until detection of the entire detection area is completed. Such partition activation is also known as scanning, or electronic scanning, in contrast to mechanical rotation-based scanning. As used herein, the term “scanning” refers to electronic scanning, unless otherwise specifically stated. At present, scanning based on the two-dimensional addressing is the most common scanning approach.

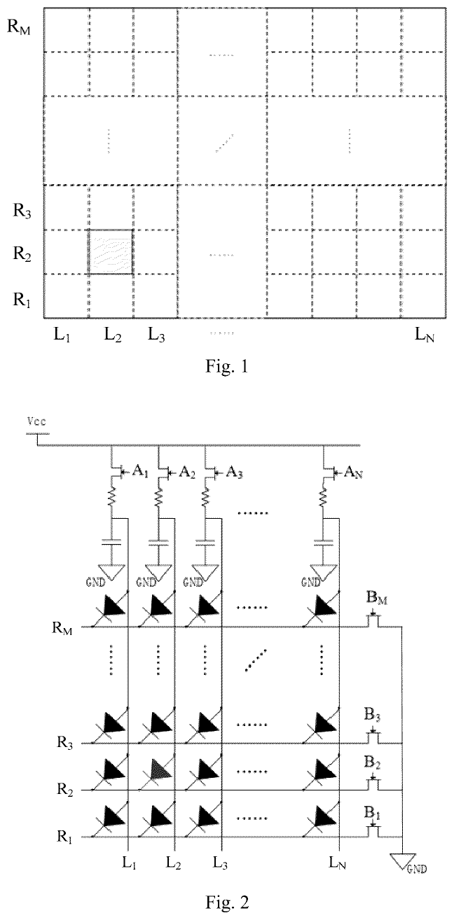

FIG. 1 shows an example of laser partitions in a planar laser array operating in a scanning mode based on two-dimensional addressing, in which the shaded area indicates a current active laser partition. As shown in FIG. 1, the planar laser array implemented in a transmitter comprises M rows (R₁-R_{M}) and N columns (L₁-L_{N}) of (i.e., M*N) laser partitions. Each laser partition comprises a plurality of laser elements. It will be understood that an associated receive (Rx) detector array may have the same partition arrangement as the planar laser array. That is, it may have M*N detector partitions arranged in M rows and N columns. Conventionally, the laser partitions are successively activated, and respective detector partitions are used to receive reflected laser signal, to achieve a scan of the entire field of view. FIG. 2 shows how the laser partitions are driven to operate in the scanning mode based on two-dimensional addressing, in which each laser partition is represented by a laser symbol. Additionally, VCC represents a power supply voltage for the circuit, and GND indicates a ground terminal.

As shown in FIG. 2, anodes of laser elements in each column of laser partitions are connected to a single charging module including a charging control component A (A₁, A₂, . . . , A_{N}), a capacitor and a resistor. The charging control component in each charging module may be selectively turned on to allow the respective capacitor to be charged for the respective column. In addition, cathodes of laser elements in each row of laser partitions are connected to a single discharging module including a discharging control component B (B₁, B₂, . . . , B_{M}). The discharging control component in discharging module may be selectively turned on to activate a laser partition at an intersection of the corresponding row wherein the discharging module is located and any column whose respective capacitor has been charged. For example, when the control component A₂ in the charging module for the column L₂ is turned on, the capacitor for the same column will be charged, and if the discharging control component B₂ in the discharging module for the row R₂ is subsequently turned on, then the laser elements in the laser partition L₂R₂ will be activated. For more details about the scanning mode based on two-dimensional addressing, reference can be made to literature in the art. In case of a large number of laser partitions, scanning the entire field of view would be quite time-consuming, leading to low scanning efficiency and a slow frame rate.

In view of this, embodiments disclosed herein provide a method for controlling a solid-state lidar including a planar laser array comprising a plurality of laser partitions and a detector array comprising a plurality of detector partitions. Each laser partition comprises a plurality of laser elements. The laser partitions in the planar laser array are in one-to-one correspondence with the detector partitions in the detector array, that is, each laser partition can provide a detection channel together with a corresponding detector partition. The detector partitions in the detector array are grouped into a plurality of detector blocks each comprising at least two detector partitions and coupled to a separate processing module. In this way, the detector partitions in each detector block share a single processing module, allowing sharing of data transmission channel, storage and processing resources for detector partitions of the same detector block.

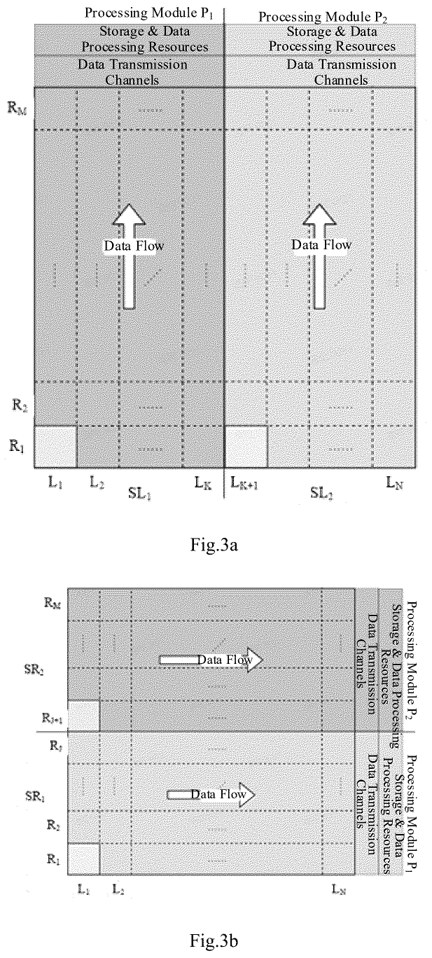

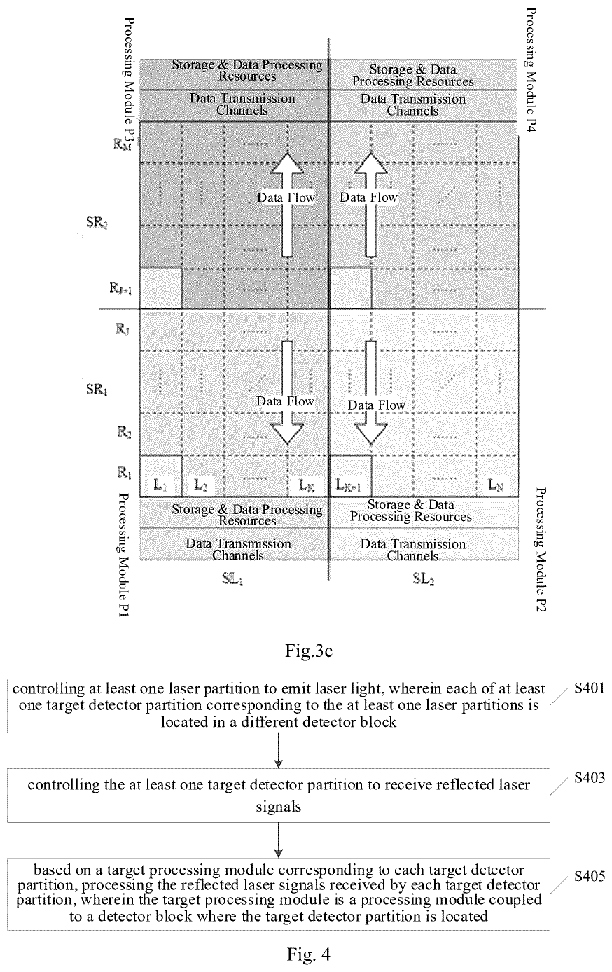

For example, the detector blocks may be arranged in the form of an array. For example, the detector partitions in the detector array may be grouped so that each detector block contains an equal number of detector partitions. FIG. 3a schematically illustrates a detector block arrangement of the detector array, in which there are two detector blocks, namely, a detector block SL₁ and a detector block SL₂, in the form of an arrangement of one row and two columns. The detector block SL₁ is coupled to a processing module P₁, and the detector block SL₂ is coupled to a processing module P₂.

FIG. 3b schematically illustrates another detector block arrangement of the detector array, in which there are two detector blocks, namely, a detector block SR₁ and a detector block SR₂, in the form of an arrangement of two rows and one column. The detector block SR₁ is coupled to a processing module P₁, and the detector block SR₂ is coupled to a processing module P₂.

FIG. 3c schematically illustrates yet another detector block arrangement of the detector array, in which there are four detector blocks, namely, a detector block SL₁&SR₁, a detector block SL₂&SR₁, a detector block SL₁&SR₂ and a detector block SL₂&SR₂, in the form of an arrangement of two rows and two columns. The detector block SL₁&SR₁ is coupled to a processing module P₁, the detector block SL₂&SR₁ to a processing module P₂, the detector block SL₁&SR₂ to a processing module P₃, and the detector block SL₂&SR₂ to a processing module P₄.

Correspondingly, FIG. 4 is a schematic flowchart of a method for controlling a solid-state lidar according to an embodiment disclosed herein, the method may include the following steps.

In S401, at least one laser partition is controlled to emit laser light.

The at least one laser partition corresponds to respective at least one detector partition each belonging to a different detector block.

In specific implementations, the at least one laser partition that emits the laser light corresponds to respective at least one detector partition each belonging to a different detector block. In the examples of FIGS. 3a and 3b, two laser partitions may be controlled to simultaneously emit the laser light, and the detector partitions corresponding to the two laser partitions are located at different detector blocks. In the example of FIG. 3c, four laser partitions may be controlled to simultaneously emit the laser light, and the detector partitions corresponding to the four laser partitions are located at different detector blocks.

In S403, at least one target detector partition is controlled to receive reflected laser signals.

Each of the target detector partition(s) refers to a detector partition in the detector array corresponding to the laser partition that emits the laser light.

In S405, based on a target processing module corresponding to each target detector partition, processing the reflected laser signals received by each target detector partition.

The target processing module is a processing module coupled to a detector block where the specific detector partition is located.

Continuing the example of FIG. 3a, the respective corresponding target detector partitions may be, for example, those at the respective lower left corners of the two detector blocks. Accordingly, the processing module P₁ that the detector block SL₁ is coupled to may process the reflected laser signals received by the target detector partition L₁&R₁, and the processing module P₂ that the detector block SL₂ is coupled to may process the reflected laser signals received by the target detector partition L_{K+1}&R₁. In this way, the reflected laser signals received by the two detection partitions can be processed in parallel.

Continuing the example of FIG. 3b, the respective corresponding target detector partitions may be, for example, those at the respective lower left corners of the two detector blocks. Accordingly, the processing module P₁ that the detector block SR₁ is coupled to may process the reflected laser signals received by the target detector partition L₁&R₁, and the processing module P₂ that the detector block SR₂ is coupled to may process the reflected laser signals received by the target detector partition L₁&R_{J+1}. In this way, the reflected laser signals received by the two detection partitions can be processed in parallel.

Continuing the example of FIG. 3c, the respective corresponding target detector partitions may be, for example, those at the respective lower left corners of the four detector blocks. Accordingly, the processing module P₁ that the detector block SL₁&SR₁ is coupled to may process the reflected laser signals received by the target detector partition L₁&R₁, and the processing module P₂ that the detector block SL₂&SR₁ is coupled to may process the reflected laser signals received by the target detector partition L_{K+1}&R₁. In addition, the processing module P₃ that the detector block SL₁&SR₂ is coupled to may process the reflected laser signals received by the target detector partition L₁&R_{J+1}, and the processing module P₄ that the detector block SL₂&SR₂ is coupled to may process the reflected laser signals received by the target detector partition L_{K+1}&R_{J+1}. In this way, the reflected laser signals received by the four detection partitions can be processed in parallel.

In an exemplary embodiment, the laser partitions in the planar laser array may also be grouped into a plurality of laser blocks each comprising at least two laser partitions and corresponding to a respective one of the detector blocks. Thus, each laser block forms a detection channel set together with the respective detector block, and each detection channel set comprises a plurality of detection channel, and each detection channel is formed by one of the laser partitions in the laser block and a respective one of the detector partitions in the respective detector block.

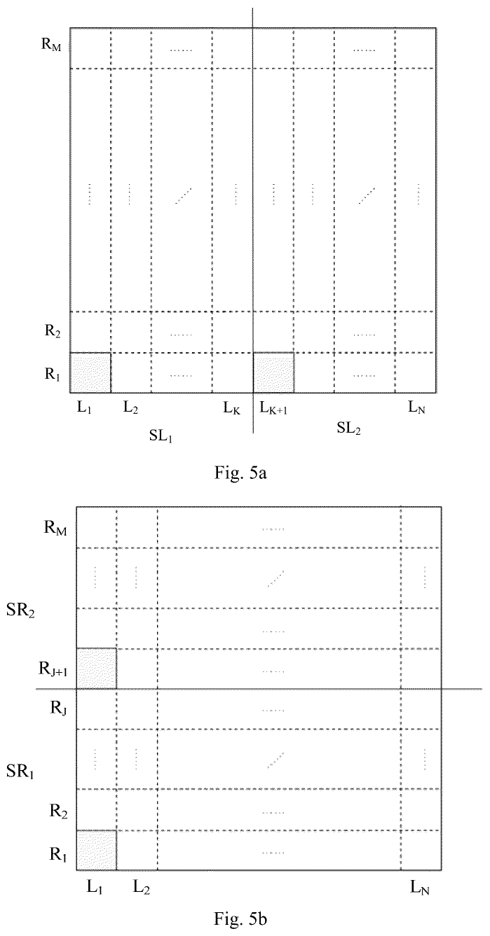

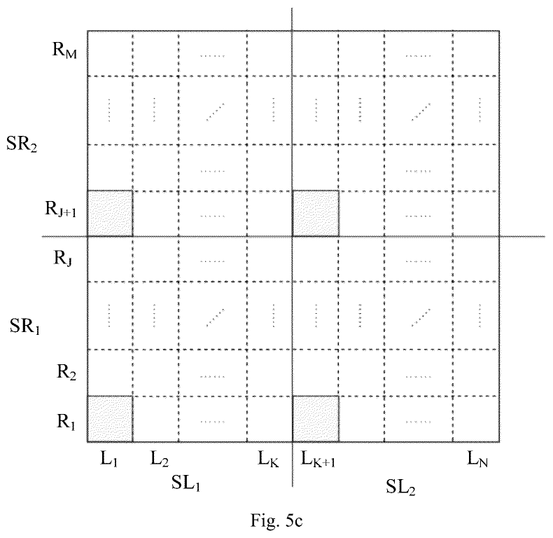

In the context of the detector block arrangements shown in FIGS. 3a to 3c, as an example, FIG. 5a schematically illustrates a laser block arrangement corresponding to FIG. 3a, in which there are two laser blocks, namely, a laser block SL₁ and a laser block SL₂, in the form of an arrangement of one row and two columns. The laser block SL₁ corresponds to the detector block SL₁, and the laser block SL₂ corresponds to the detector block SL₂.

FIG. 5b schematically illustrates another laser block arrangement corresponding to FIG. 3b, in which there are two laser blocks, namely, a laser block SR₁ and a laser block SR₂, in the form of an arrangement of two rows and one column. The laser block SR₁ corresponds to the detector block SR₁, and the laser block SR₂ corresponds to the detector block SR₂.

FIG. 5c schematically illustrates yet another laser block arrangement corresponding to FIG. 3c, in which there are four laser blocks, namely, a laser block SL₁&SR₁, a laser block SL₂&SR₁, a laser block SL₁&SR₂ and a laser block SL₂&SR₂, in the form of an arrangement of two rows and two columns. The laser block SL₁&SR₁ corresponds to the detector block SL₁&SR₁, the laser block SL₂&SR₁ to the detector block SL₂&SR₁, the laser block SL₁&SR₂ to the detector block SL₁&SR₂, and the laser block SL₂&SR₂ to the detector block SL₂&SR₂.

It will be understood that when the detector blocks are arranged into an arrangement as shown in FIG. 3c which is an arrangement of two rows and two columns, it is also possible for the laser blocks to be arranged as shown in FIG. 5a or 5b. For example, in the case of FIG. 5a, the laser block SL₁ may correspond to both the detector blocks SL₁&SR₁ and SL₁&SR₂, and the laser block SL₂ may correspond to both the detector blocks SL₂&SR₁ and SL₂&SR₂. Similarly, in the case of FIG. 5b, the laser block SR₁ may correspond to both the detector blocks SL₁&SR₁ and SL₂&SR₁, and the laser block SR₂ may correspond to both the detector blocks SL₁&SR₂ and SL₂&SR₂.

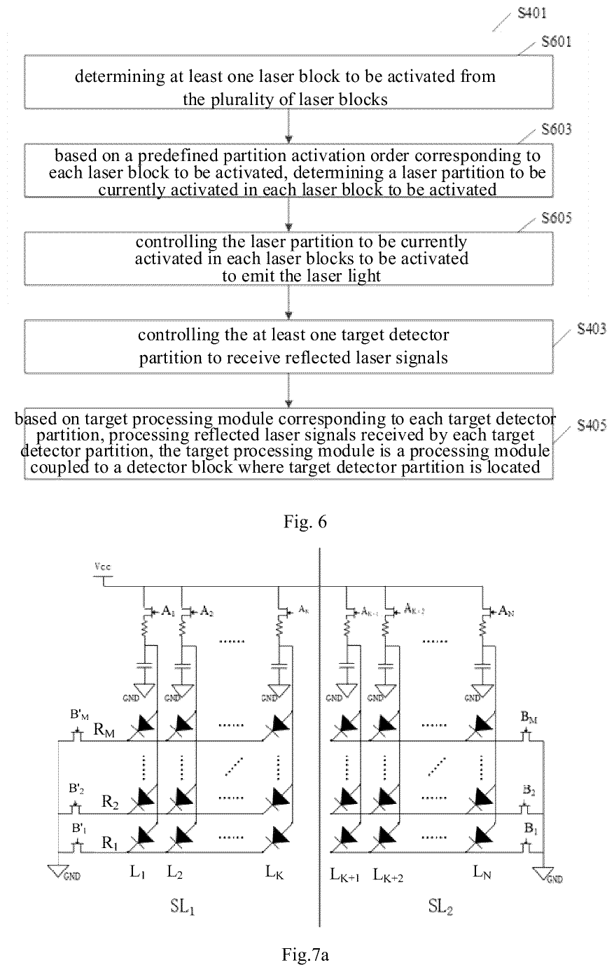

Correspondingly, step S401, in which the at least one laser partition is controlled to emit the laser light, may include the following sub-steps, as shown in FIG. 6.

In S601, at least one of the laser blocks to be activated is determined.

In S603, according to a predefined partition activation order for each laser block to be activated, a laser partition to be currently activated in the laser block to be activated is determined.

In S605, the laser partition(s) to be currently activated in the respective laser block(s) to be activated is/are controlled to emit the laser light.

Specifically, the at least one of the laser blocks to be activated may be determined according to a block determination strategy, which may be formulated according to an actual need. For example, all the laser blocks may be determined as laser blocks to be activated at each scanning, and one laser partition in each laser block may be activated to emit laser light in each scanning. In general terms, more laser blocks that are determined as laser blocks to be activated at each scanning mean higher scanning efficiency.

According to embodiments disclosed herein, one laser partition may be activated to emit laser light separately in each laser block. The predefined partition activation order is an order of successively activation of partition in respective laser block, optionally the predefined partition activation order may be configured according to an actual need, for example, from the left rightward, from the top downward, etc. The predefined partition activation orders for different laser blocks may be the same or different.

In the driving mode of FIG. 2, it is impossible for different laser partitions in the same columns to be independently activated at the same time. For example, in an attempt to simultaneously activate two laser partitions of the same column, the charging control component A for the column is first turned on to allow the respective capacitor to be charged, and the discharging control components B for the rows that the two laser partitions belong to are simultaneously turned on to allow the two laser partitions to simultaneously emit laser light. However, in practical use, there is inevitably a slight difference between the turn-on times of the discharging control components B for the two rows, leading to a difference in luminous intensity between the two laser partitions, or even failure of one of the laser partitions to emit light.

In order to address this problem, i.e., to enable one laser partition to be activated to emit laser light separately in each laser block, in an exemplary embodiment, each laser block is coupled to a driving module including a plurality of charging modules and a plurality of discharging module, which together form a plurality of driving channels. Input terminals of laser partitions of a single column in each laser block are connected to a single charging module in the respective driving module, and output terminals of laser partitions of a single row in each laser block are connected to a single discharging module in the respective driving module.

The input terminal of each laser partition includes anodes of laser elements in the laser partition, and the output terminal of each laser partition includes cathode of laser elements in the laser partition. Each charging module includes a charging control component, a resistor and a capacitor. Turning on the charging control component allows the charging module, more precisely, the capacitor therein to be charged, and the charging module is not charged anymore once the charging control component is turned off. Each discharging module includes a discharging control component, and is allowed to be discharged when the discharging control component is turned on. When this happens, any laser partition, whose anodes are connected to a charged charging module and whose cathodes are connected to the specific discharging module, will be activated, allowing laser elements therein to emit laser light. The charging control components and the discharging control components may be implemented as transistor switches.

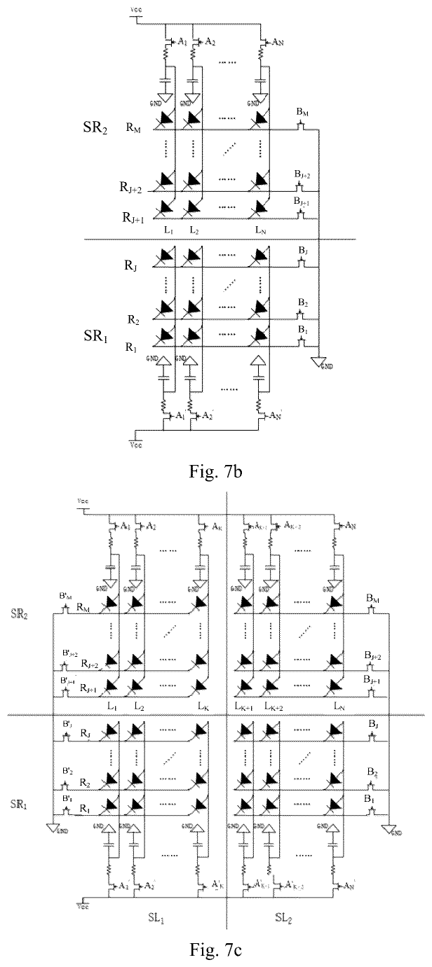

In the example of FIG. 5a, the M×N laser partitions in the planar laser array are grouped into two laser blocks SL₁ and SL₂ in the form of one row and two columns. The laser block SL₁ includes M×K laser partitions, and the laser block SL₂ includes M×(N−K) laser partitions. FIG. 7a schematically illustrates coupling of driving modules for FIG. 5a, in which each laser partition is represented by a laser symbol.

As shown in FIG. 7a, each of the laser blocks SL₁ and SL₂ is coupled to a respective driving module. For example, the driving module coupled to the laser block SL₁ includes K charging modules (i.e., the circuit block that comprises the charging control components A₁ to AK in FIG. 7a) and M discharging modules (i.e., the circuit block that comprises the discharging control components B′₁ to B′_{M} in FIG. 7b). The K charging modules are in one-to-one correspondence with the K columns of the laser block SL₁, and input terminals of laser partitions of a single column in the laser block SL₁ are connected to a respective charging module corresponding to the column. The M discharging modules are in one-to-one correspondence with the M rows of the laser block SL₁, and output terminals of laser partitions of a single row in the laser block SL₁ are connected to a respective discharging module corresponding to the row.

In the example of FIG. 5b, the M×N laser partitions in the planar laser array are grouped into two laser blocks SR₁ and SR₂ in the form of two rows and one column. The laser block SR₁ includes J×N laser partitions, and the laser block SR₂ includes (M−J)×N laser partitions. FIG. 7b schematically illustrates coupling of driving modules for FIG. 5b, in which each laser partition is represented by a laser symbol.

As shown in FIG. 7b, each of the laser blocks SR₁ and SR₂ is coupled to a respective driving module. For example, the driving module coupled to the laser block SR₁ includes N charging modules (i.e., the circuit block that comprises the charging control components A′₁ to A′_{N} in FIG. 7b) and J discharging modules (i.e., the circuit block that comprises the discharging control components B₁ to B_{J} in FIG. 7b). The N charging modules are in one-to-one correspondence with the N columns of the laser block SR₁, and input terminals of laser partitions of a single column in the laser block SR₁ are connected to a respective charging module corresponding to the column. The J discharging modules are in one-to-one correspondence with the J rows of the laser block SR₁, and output terminals of laser partitions of a single row in the laser block SR₁ are connected to a respective discharging module corresponding to the row.

In the example of FIG. 5c, the M×N laser partitions in the planar laser array are grouped into four laser blocks SL₁&SR₁, SL₂&SR₁, SL₁&SR₂ and SL₂&SR₂ in the form of two rows and two columns. The laser block SL₁&SR₁ includes J×K laser partitions, the laser block SL₂&SR₁ includes J×(N−K) laser partitions, the laser block SL₁&SR₂ includes (M−J)×K laser partitions, and the laser block SL₂&SR₂ includes (M−J)×(N−K) laser partitions. FIG. 7c schematically illustrates coupling of driving modules for FIG. 5c, in which each laser partition is represented by a laser symbol.

As shown in FIG. 7c, each of the laser blocks SL₁&SR₁, SL₂&SR₁, SL₁&SR₂, SL₂&SR₂ is coupled to a corresponding driving module. For example, the driving module coupled to the laser block SL₁&SR₁ includes K charging modules (i.e., the circuit block that comprises the charging control components A′₁ to A′_{K} in FIG. 7c) and J discharging modules (i.e., the circuit block that comprises the discharging control components B′₁ to B′_{J} in FIG. 7c). The K charging modules are in one-to-one correspondence with the K columns of the laser block SL₁&SR₁, and input terminals of laser partitions of a single column in the laser block SL₁&SR₁ are connected to a respective charging module corresponding to the column. The J discharging modules are in one-to-one correspondence with the J rows of the laser block SL₁&SR₁, and output terminals of laser partitions of a single row in the laser block SL₁&SR₁ are connected to a respective discharging module corresponding to the row.

In an alternative exemplary embodiment, the laser blocks are arranged into an array, in which each row of laser blocks is coupled to a respective driving module including a plurality of charging modules and a plurality of discharging modules, which together form a plurality of driving channels. Output terminals of a single row of laser partitions in the same row of laser block are connected to a respective discharging module in the respective driving module. That is, cathodes of laser elements of laser partitions, which belong to different laser blocks and are in the same row, are connected to the same respective discharging module. Further, input terminals of a single column of laser partitions in each laser block of the same row of laser block are connected to a respective charging module in the respective driving module.

Taking two laser blocks SL₁ and SL₂ (arranged in 1 row×2 columns) shown in FIG. 5a as an example, their driving module coupling configuration can be represented by the schematic in FIG. 2. However, in this case, when two laser partitions of a single row are simultaneously activated, a maximum discharge current through a discharging module will be doubled. Therefore, this scheme is suitable for scenarios with a relatively small driving current for each single laser partition in the consideration of easy availability of suitable discharging control components capable of handling simultaneous activation of two laser partitions.

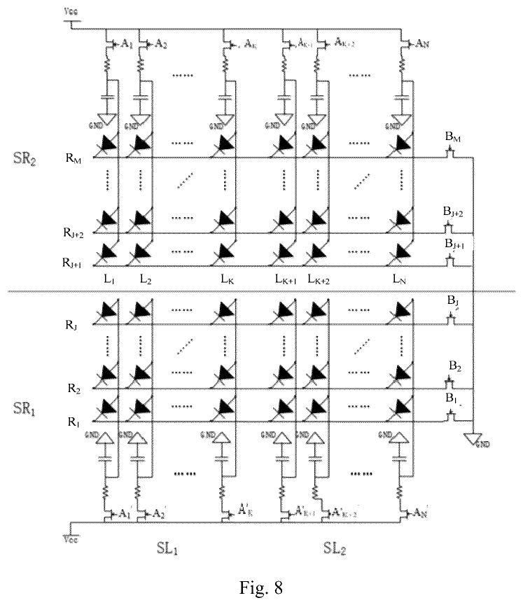

Taking four laser blocks SL₁&SR₁, SL₂&SR₁, SL₁&SR₂, and SL₂&SR₂ (arranged in 2 rows×2 columns) as shown in FIG. 5c as an example, FIG. 8 schematically illustrates alternative coupling of driving modules corresponding to FIG. 5, in which each laser partition is represented by a laser symbol.

As shown in FIG. 8, the laser blocks SL₁&SR₁ and SL₂&SR₁ are located in the same row and coupled to a single driving module, and the laser blocks SL₁&SR₂ and SL₂&SR₂ are located in the same row and coupled to another single driving module. Taking laser blocks SL₁&SR₁ and SL₂&SR₁ as an example for illustration. The driving module that the laser blocks SL₁&SR₁ and SL₂&SR₁ are coupled to includes N charging modules (i.e., the circuit block comprises the charging control components A′₁ to A′_{N} in FIG. 8) and J discharging modules (i.e., the circuit block comprises the discharging control components B₁ to B_{J} in FIG. 8). The N charging modules are in one-to-one correspondence with K columns in the laser block SL₁&SR₁ and (N−K) columns in the laser block SL₂&SR₁, input terminals of laser partitions of the same column in the laser block SL₁&SR₁ are connected to a respective charging module corresponding to the column, and input terminals of laser partitions of the same column in the laser block SL₂&SR₁ are connected to a respective charging module corresponding to the column. The J discharging modules are in one-to-one correspondence with J rows in the laser blocks SL₁&SR₁ and SL₂&SR₁, output terminals of laser partitions of the same row in the laser blocks SL₁&SR₁ and SL₂&SR₁ are connected to a respective discharging module corresponding to the row.

Correspondingly, step S605, in which the laser partition(s) to be currently activated in the respective laser block(s) to be activated is/are controlled to emit the laser light, may include:
for each laser partition to be currently activated in the laser block to be activated, controlling the target charging module (in the driving module coupled to corresponding laser block to be activated) coupled to the laser partition to be currently activated to enter the charging state; and
controlling the target discharging module (in the driving module coupled to corresponding laser block to be activated) coupled to the laser partition to be currently activated to enter the discharging state, thereby activating a target driving channel formed by the charging module and the discharging module to activate the laser partition to be currently activated in the laser block to be activated to emit the laser light.

It will be understood that before the discharging module enters the discharging state, the charging must be completed.

Taking FIG. 7a as an example, with laser blocks SL₁ and SL₂ to be activated, the laser partition to be currently activated in SL₁ is L₁R₁ and the laser partition to be currently activated in SL₂ is Lₖ₊₁R₁, for the laser partition L₁R₁ currently to be activated in SL₁: the circuit module comprising the charging control component A₁ represents the target charging module (in driving module where the SL₁ is coupled) coupled to L₁R₁; the circuit module comprising the discharging control component B′₁ represents the target discharging module (in driving module where the SL₁ is coupled) coupled to L₁R₁. Turning on the charging control component A₁ to allow charging of the target charging module connected thereto. After the charging is completed, turning on the discharging control component B′₁ to allow discharging of the target discharging module connected thereto, thereby driving laser elements in L₁R₁ to emit laser light. Likewise, for the laser partition Lₖ₊₁R₁ currently to be activated in SL₂: the circuit module comprising the charging control component Aₖ₊₁ represents the target charging module (in driving module coupled to SL₂) connected to L_{K+1}R₁; the circuit module comprising the discharging control component B₁ represents the target discharging module (in driving module coupled to the SL₁) connected to L_{K+1}R₁. Turning on the charging control component A_{K+1} to allow charging of the target charging module connected thereto. After the charging is completed, turning on the discharging control component B₁ to allow discharging of the target discharging module connected thereto, thereby driving laser elements in L_{K+1}R₁ to emit laser light. Therefore, through grouping the planar laser array into two laser blocks in the form of one row and two columns, as described herein, the laser partitions in the two laser blocks can be individually activated, compared with the activation scheme of FIG. 2. Moreover, this can achieve an increase in scanning efficiency of up to 200%, or reduce the size of each single partition to ½ at the same scanning efficiency. Smaller partitions mean reduced likelihood of crosstalk between different channels.

It will be understood that, if laser blocks SR₁ and SR₂ are to be activated in FIG. 7b, individual activation of the laser partition L₁R₁ in the laser block SR₁ and the laser partition L₁R_{J+1} in the laser block SR₂ can be achieved using a similar control approach as described above for the example of FIG. 7a. Therefore, through grouping the planar laser array into two laser blocks in the form of two rows and one column, as described herein, the laser partitions in the two laser blocks can still be individually activated, compared with the activation scheme of FIG. 2. Moreover, this can achieve an increase in scanning efficiency of up to 200%, or reduce the size of each single partition to ½ at the same scanning efficiency. Smaller partitions mean reduced likelihood of crosstalk between different channels.

It will be understood that, if laser blocks SL₁&SR₁, SL₂&SR₁, SL₁&SR₂ and SL₂&SR₂ are to be activated in FIG. 7c and, individual activation of the laser partition L₁R₁ in the laser block SL₁&SR₁, the laser partition Lₖ₊₁R₁ in the laser block SL₂&SR₁, the laser partition L₁R_{J+1} in the laser block SL₁&SR₂ and the laser partition Lₖ₊₁R_{J+1} in the laser block SL₂&SR₂ can be achieved using a similar control approach as described above for the example of FIG. 7a. Therefore, through grouping the planar laser array into four laser blocks in the form of a two rows and two columns, as described herein, the laser partitions in the four laser blocks can still be individually activated, compared with the activation scheme of FIG. 2. Moreover, this can achieve an increase in scanning efficiency of up to 400%, or reduce the size of each single partition to ¼ at the same scanning efficiency. Smaller partitions mean reduced likelihood of crosstalk between different channels.

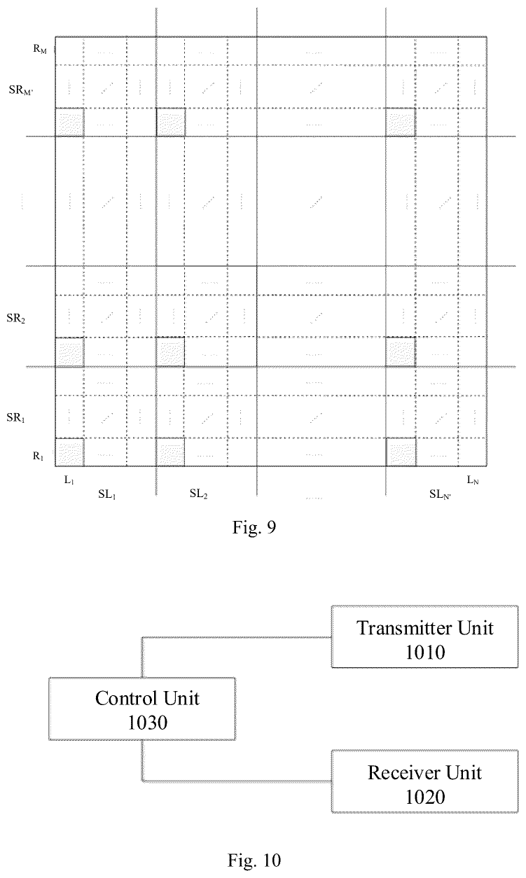

In practical applications, in order to reduce possible crosstalk between active laser partitions in different laser blocks, these laser partitions are desired to be spaced apart as large distance as possible. To this end, the M×N laser partitions may be grouped into M′×N′ laser blocks and activated block-wise, as shown in FIG. 9, in which the shaded areas represent active laser partitions in the respective blocks. In each scanning, partitions at the same location in the respective blocks may be activated.

Therefore, in a method according to an embodiment of this application, a planar laser array comprising M×N laser partitions may be grouped into M′×N′ laser blocks, and a detector array comprising M×N detector partitions may be grouped into M′×N′ detector blocks. In addition, scanning can be achieved based on two-dimensional addressing, with one laser partition being activated separately in each laser block. This can not only avoid differences in luminous intensity between simultaneously activated laser partitions, but can also achieve an increase in scanning efficiency of up to M′*N′ times at the same size of each laser partition, or reduce the size of each partition to 1/(M′*N′) at the same scanning efficiency. Smaller partitions mean reduced likelihood of crosstalk between different detection channels.

Embodiments disclosed herein also provide a solid-state lidar, which includes transmitter unit 1010, a receiver unit 1020 and a control unit 1030, as shown in FIG. 10.

The transmitter unit 1010 includes a planar laser array comprising a plurality of laser partitions each comprising a plurality of laser elements. The plurality of laser partitions may be arranged into an array, and the laser elements may be implemented as vertical-cavity surface-emitting laser (VCSEL).

The receiver unit 1020 includes a detector array and a plurality of processing modules. The detector array comprises a plurality of detector partitions in one-to-one correspondence with the plurality of laser partitions. The plurality of detector partitions is grouped into a plurality of detector blocks each comprising at least two detector partitions. Each detector block is coupled to a different processing module. For example, the plurality of detector partitions may be arranged into an array, and the detector may be implemented as a planar array of photosensitive elements, such as single-photon avalanche diodes (SPADs). For more details of the receiver unit 1020, reference is made to the above description in connection with FIGS. 3a, 3b and 3c.

The control unit 1030 is coupled to the transmitter unit 1010 and the receiver unit 1020 and is configured to control at least one laser partition to emit laser light and to control at least one target detector partition, which corresponds to the respective at least one laser partition, to receive reflected laser signals. It is also configured to process reflected laser signals received at each target detector partition by a respective one of the processing modules, which corresponds to the target detector partition. The at least one target detector partition each is located in a different detector block, and the target processing module is a processing module coupled to the detector block that the detector partition is located.

In some possible embodiments, the laser partitions in the planar laser array are grouped into a plurality of laser blocks each comprising at least two of the laser partitions and corresponding to a different detector block.

Accordingly, in order to control the at least one laser partition to emit the laser light, the control unit 1030 is configured to: determine at least one of the laser blocks to be activated; according to a predefined partition activation order corresponding to each laser block to be activated, determine a current laser partition to be currently activated in the laser block to be activated; and control the laser partition(s) to be currently activated in the respective laser block(s) to be activated to emit the laser light.

In some possible embodiments, the transmitter unit 1010 further includes a plurality of driving modules each coupled to a respective laser block. Each driving module includes a plurality of charging modules and a plurality of discharging modules, which together form a plurality of driving channels.

Input terminals of each column of laser partitions in each laser block are connected to the same charging modules in the driving module that the laser block is coupled to, and output terminals of each row of laser partitions in each laser block are connected to the same discharging modules in the driving module that the laser block is coupled to.

For more details of the coupling of a plurality of the laser blocks in the planar laser array to a plurality of driving modules in these embodiments, reference is made to the above description in connection with FIGS. 7a, 7b and 7c, and further description thereof is omitted here for the sake of brevity.

In some other possible embodiments, the plurality of laser blocks is arranged into an array, and the plurality of detector blocks is also arranged into an array. Additionally, the transmitter unit 1010 further includes a plurality of driving modules. Each row of laser blocks is coupled to a respective driving module, and each driving module includes a plurality of charging modules and a plurality of discharging modules, which together form a plurality of driving channels.

Further, output terminals of each row of laser partitions in each row of laser blocks are connected to the same discharging modules in the driving module that the row of laser blocks is coupled to, and input terminals of each column of laser partitions in each laser block in each row of laser blocks are connected to the same charging module in the driving module that the row of laser blocks is coupled to. In other words, output terminals of laser partitions in different laser blocks of a single row are connected to a single discharging module in the driving module that the row of laser blocks is coupled to, and input terminals of a single column of laser partitions in each laser block are connected to a single charging module in the driving module that the row comprising the specific laser block is coupled to.

For more details of the coupling of the plurality of laser blocks in the planar laser array to the plurality of driving modules in these embodiments, reference is made to the above description in connection with FIG. 8, and further description thereof is omitted here for the sake of brevity.

Accordingly, controlling the laser partition(s) to be currently activated in the respective laser block(s) to be activated to emit the laser light, the control unit 1030 is configured to, for each laser partition to be currently activated in the respective laser block to be activated, control the target charging module (in the driving module coupled to the corresponding laser block to be activated) coupled to the laser partition to be currently activated to enter the charging state, and control the target discharging module (in the driving module coupled to the corresponding laser block to be activated) coupled to the laser partition to be currently activated to enter the discharging state, thereby activating a target driving channel formed by the charging module and the discharging module to drive the laser partition to be currently activated in the laser block to be activated to emit the laser light. For more details of this, reference is made to the foregoing description, and further description thereof is omitted here for the sake of brevity.

This solid-state lidar is capable of scanning based on two-dimensional addressing, with one laser partition being activated separately in each laser block. This can not only avoid differences in luminous intensity between simultaneously activated laser partitions, but can also achieve an increase in scanning efficiency of up to M′*N′ times at the same size of each laser partition, or reduce the size of each partition to 1/(M′*N′) at the same scanning efficiency. Smaller partition s mean reduced likelihood of crosstalk between different detection channels.

It should be noted that although the foregoing embodiments are described above in a certain order, this is only for ease of description and does not imply any priority of one embodiment over another. While particular embodiments hereof have been described above, there are also other embodiments within the scope of the appended claims. In some cases, actions or steps recited in the claims may be carried out in a different order than in the embodiments while still achieving desirable results. In addition, the processes depicted in the accompanying drawings do not necessarily require the particular order shown, or sequential order, to achieve desirable results. In certain implementations, multitasking and parallel processing may be feasible or advantageous.

The embodiments disclosed herein are described in a progressive manner, with the description of each embodiment focusing on its differences from others. Cross reference can be made between the embodiments for their common or similar features. Since the device embodiments correspond to the method embodiments, they are described relatively briefly, and reference can be made to the method embodiments for more details thereof.

Those of ordinary skill in the art will understand that all or some of the steps in the foregoing embodiments may be implemented by hardware possibly under the instruction of a program, which may be stored in a computer-readable storage medium such as a read-only memory, a magnetic diskette or a compact disc read-only memory (CD-ROM).

Presented above are some exemplary embodiments of the present application, and they are not intended to limit this application in any way. Any and all alterations, equivalent substitutions, modifications and so on made within the spirit and principles of the present application are considered to fall within the scope of protection of this application.

1. A method for controlling a solid-state lidar, wherein the solid-state lidar comprises a planar laser array including a plurality of laser partitions and a detector array including a plurality of detector partitions, wherein each laser partition comprises a plurality of laser elements, wherein the plurality of laser partitions is in one-to-one correspondence with the plurality of detector partitions, wherein the plurality of detector partitions are grouped into a plurality of detector blocks, wherein each detector block comprises at least two detector partitions, wherein each detector block is coupled to a different processing module, and wherein the method comprises:
controlling at least one laser partition to emit laser light, wherein each of at least one target detector partition corresponding to the at least one laser partitions is located in a different detector block;
controlling the at least one target detector partition to receive reflected laser signals; and
based on a target processing module corresponding to each target detector partition, processing the reflected laser signals received by each target detector partition, wherein the target processing module is a processing module coupled to a detector block where the target detector partition is located.

2. The method of claim 1, wherein the plurality of laser partitions is grouped into a plurality of laser blocks, wherein each laser block comprises at least two laser partitions and corresponds to a different detector block,
wherein controlling the at least one laser partition to emit the laser light comprises:
determining at least one laser block to be activated from the plurality of laser blocks;
based on a predefined partition activation order corresponding to each laser block to be activated, determining a laser partition to be currently activated in each laser block to be activated; and
controlling the laser partition to be currently activated in each laser blocks to be activated to emit the laser light.

3. The method of claim 2, wherein each laser block is coupled to a corresponding driving module, wherein each driving module comprises a plurality of charging modules and a plurality of discharging modules, wherein the plurality of charging modules and the plurality of discharging modules form a plurality of driving channels,
wherein input terminals of a same column of laser partitions in each laser block are connected to a same charging module in a corresponding driving module, and wherein output terminals of a same row of laser partitions in each laser block are connected to a same discharging module in a corresponding driving module.

4. The method of claim 2, wherein the plurality of laser blocks is arranged into an array, with the plurality of detector blocks being arranged into an array,
wherein each row of the plurality of laser blocks is coupled to a corresponding driving module, wherein the driving module comprises a plurality of charging modules and a plurality of discharging modules, and wherein the plurality of charging modules and the plurality of discharging modules form a plurality of driving channels;
output terminals of each row of the laser partitions in each row of the laser block are connected to a same discharging module in a corresponding driving module; and
input terminals of each column of laser partitions in each laser block in a same row of laser blocks are connected to a same charging module in a corresponding driving module.

5. The method of claim 3, wherein controlling the laser partition to be currently activated in each laser block to be activated to emit the laser light comprises:
for a laser partition to be currently activated in each laser block to be activated:
controlling a target charging module in the driving module coupled to the laser block to be activated, to which the laser partition to be currently activated is coupled to enter a charging state; and
controlling a target discharging module in the driving module coupled to the laser block to be activated, to which the laser partition to be currently activated is coupled to enter a discharging state, thereby activating a target driving channel that is formed by the target charging module and the target discharging module, so as to drive the laser partition to be currently activated in the laser block to be activated to emit the laser light.

6. A solid-state lidar, comprising:
a transmitter unit comprising a planar laser array including a plurality of laser partitions, wherein each laser partition comprises a plurality of laser elements;
a receiver unit comprising a detector array and a plurality of processing modules, wherein the detector array comprises a plurality of detector partitions that are in one-to-one correspondence with the plurality of laser partitions, wherein the plurality of detector partitions is grouped into a plurality of detector blocks, wherein each detector block comprises at least two detector partitions and is coupled to a different processing module; and
a control unit coupled to each of the transmitter unit and the receiver unit, wherein the control unit configured to: control at least one laser partition to emit laser light; control at least one target detector partition which corresponds to the at least one laser partition to receive reflected laser signals; and based on each target processing module corresponding to a target detector partition, processing the reflected laser signals received by each target detector partition, wherein each of at least one target detector partition is located in a different detector block, and wherein the target processing module is a processing module coupled to the detector block where the detector partition is located.

7. The solid-state lidar of claim 6, wherein the plurality of laser partitions in the planar laser array is grouped into a plurality of laser blocks, wherein each laser block comprises at least two laser partitions and corresponds to a different detector block,
wherein controlling the at least one laser partition to emit the laser light, the control unit is configured to: determine at least one laser block to be activated from the plurality of laser blocks; based on a predefined partition activation order corresponding to each laser block to be activated, determine a laser partition to be currently activated in the laser block to be activated; and control the laser partition to be currently activated in each laser block to be activated to emit the laser light.

8. The solid-state lidar of claim 7, wherein the transmitter unit further comprises a plurality of driving modules, wherein each driving module is coupled to a corresponding laser block, wherein each driving module comprises a plurality of charging modules and a plurality of discharging modules, and wherein the plurality of charging modules and the plurality of discharging modules form a plurality of driving channels,
wherein input terminals of a same column of laser partitions in each laser block are connected to a same charging module in a corresponding driving module, and wherein output terminals of a same row of laser partitions in each laser block are connected to a same discharging module in a corresponding driving module.

9. The solid-state lidar of claim 7, wherein the plurality of laser blocks is arranged into an array, with the plurality of detector blocks being arranged into an array,
wherein the transmitter unit further comprises a plurality of driving modules, wherein each driving module is coupled to a row of laser blocks of the plurality of laser blocks, wherein each driving module comprises a plurality of charging modules and a plurality of discharging modules, and wherein the plurality of charging modules and the plurality of discharging modules form a plurality of driving channels;
output terminals of a same row of laser partitions in a same laser block are connected to a same discharging module in a corresponding driving module; and
input terminals of a same column of laser partitions in each laser block in a same row of laser blocks are connected to a same charging module in a corresponding driving module.

10. The solid-state lidar of claim 8, wherein controlling the laser partition to be currently activated in each laser block to be activated to emit the laser light, the control unit is configured to,
for a laser partition to be currently activated in each laser block to be activated,
control target charging module in the driving module coupled to the laser block to be activated, to which the laser partition to be currently activated is coupled to enter a charging state; and
control a target discharging module in the driving module coupled to the laser block to be activated, to which the laser partition to be currently activated is coupled to enter a discharging state, thereby activating the driving channel that is formed by the target charging module and the target discharging module, so as to drive the laser partition to be currently activated in the laser block to be activated to emit the laser light.

11. The method of claim 4, wherein controlling the laser partition to be currently activated in each laser block to be activated to emit the laser light comprises:
for a laser partition to be currently activated in each laser block to be activated:
controlling a target charging module in the driving module coupled to the laser block to be activated, to which the laser partition to be currently activated is coupled to enter a charging state; and
controlling a target discharging module in the driving module coupled to the laser block to be activated, to which the laser partition to be currently activated is coupled to enter a discharging state, thereby activating a target driving channel that is formed by the target charging module and the target discharging module, so as to drive the laser partition to be currently activated in the laser block to be activated to emit the laser light.

12. The solid-state lidar of claim 9, wherein controlling the laser partition to be currently activated in each laser block to be activated to emit the laser light, the control unit is configured to,
for a laser partition to be currently activated in each laser block to be activated,
control target charging module in the driving module coupled to the laser block to be activated, to which the laser partition to be currently activated is coupled to enter a charging state; and
control a target discharging module in the driving module coupled to the laser block to be activated, to which the laser partition to be currently activated is coupled to enter a discharging state, thereby activating the driving channel that is formed by the target charging module and the target discharging module, so as to drive the laser partition to be currently activated in the laser block to be activated to emit the laser light.

13. A method for controlling a solid-state lidar, wherein the solid-state lidar comprises a planar laser array including a plurality of laser partitions and a detector array including a plurality of detector partitions, wherein each laser partition comprises a plurality of laser elements, wherein the plurality of laser partitions is in one-to-one correspondence with the plurality of detector partitions, wherein the plurality of detector partitions are grouped into a plurality of detector blocks, wherein each detector block comprises at least two detector partitions, wherein each detector block is coupled to a different processing module, wherein the plurality of laser partitions is grouped into a plurality of laser blocks, wherein each laser block comprises at least two laser partitions and corresponds to a different detector block, and wherein the method comprises:
controlling at least two laser partitions to simultaneously emit laser light, wherein at least two target detector partitions corresponding to the at least two laser partitions are located in different detector blocks;
controlling the at least two target detector partitions to simultaneously receive reflected laser signals of the laser partitions corresponding to the at least two target detector partitions; and
based on a target processing module corresponding to each target detector partition, processing the reflected laser signals received by each target detector partition, wherein the target processing module is a processing module coupled to a detector block where the target detector partition is located.
